(19) United States
(12) Patent Application Publication
(10) Pub. No.: US 2005/0174351 A1
(43) Pub. Date: Aug. 11, 2005

(54) Method and apparatus for large-scale two-dimensional mapping

(76) Inventor: Yuh-Jye Chang, Bridgewater, NJ (US)

Correspondence Address: Docket Administrator (Room 3J-219);Lucent Technologies Inc., 101 Crawfords Corner Road, Holmdel, NJ, 07733-3030, US

(21) Appl. No.: 10/776,873

(22) Filed: Feb. 11, 2004

(51) Int. Cl. G06T 11/20; G09G 5/00

(52) U.S. Cl. 345/440

(57) ABSTRACT

A method and apparatus for achieving the storing, manipulating and rendering of large-scale 2D displays (e.g., a large-scale communications network topology) using a conventional computer system and its secondary memory. Utilizing a modified quad tree data structure in combination with certain indexing and viewing methodologies achieves the storing, loading, rending, and navigating of, large-scale topologies utilizing the secondary memory of a conventional computer system.

### FIELD OF THE INVENTION

The present invention relates generally to the display of information in a computer system and, more particularly, to the display of information regarding a large number of objects.

### BACKGROUND OF THE INVENTION

A significant problem for users of computer systems is that there are displays of information accessible through the computer system which, due to the voluminous nature of the information underlying the display, make it difficult to render the full complement of the information on a two-dimensional (“2D”) display in a fully comprehensible fashion to the user.

For example, the graphical display and representation of information related to a communications network presents a significant challenge with regard to rending a meaningful 2D display of the relevant network information. That is, in terms of a graphical representation, a communications network is inter alia a collection of nodes which are pairwise connected by links. The nodes of the graph could represent communications switches resident in the network, and the links could represent connections between such switches. For illustrative purposes, FIG. 1 shows a prior art display of certain information with respect to an illustrative communications network topology. As shown in FIG. 1, display 100 represents an illustrative worldwide communications network as a collection of nodes (e.g., node 120) and links (e.g., link 110). As such a display begins to increase in density (i.e., additional nodes and/or links are included in the communications network) the display of the network information becomes increasingly more difficult to complete such that the display shows a meaningful 2D representation to the user. In fact, in terms of today's network topologies it is not uncommon to have a topology that could have more than 10,000 nodes and more than 100,000 links.

To compound matters, the visualization of large-scale networks (e.g., networks containing in excess of 10,000 nodes and 10,000 links) using a client user interface program executing on a conventional computer system (i.e., a typical personal computer, or stand alone workstation, having a single processing unit with limited processing capabilities as compared to higher performance computer systems such as a server, mainframe or super computer having more expansive processing power) becomes increasingly challenging. Known graphical user interface (“GUI”) methodologies typically handle 2D mapping by loading the complete network topology into main memory. Obviously, this type of memory loading may impact performance of at least the user interface program used to render the display. In order to improve performance, such GUI methodologies employ alternative data structure arrangements. One such known data structure arrangement is the so-called “bounding box test” (see, for example, H. Weghorst, G. Hopper and D. P. Greenberg, “Improved Computational Methods for Ray Tracing”, ACM TOG, 3(1), January 1984, pages 52-69), where such bounding box test improves efficiency by the avoidance of rending unnecessary objects (e.g., a node) when such objects are out range (i.e., out of a particular viewer's defined viewing range). While such data structure arrangements like the above-described bounding box test improve the speed by which a GUI program renders displays, such arrangements have a complexity of O(N) which make them undesirable for use with large-scale network topologies. That is, the complexity of these arrangements increases directly as the number of objects increases due to the requirement that every object will need examination before determining whether such object is out of range.

There are a number of well-known alternatives for reducing the complexity associated with the manipulation of large-scale networks in rendering a graphical representation of the large-scale network. For example, the so-called “binary space partition tree” (see, for example, Fuchs, Kedem and Naylor, “Predetermining Visibility Surface Generation in 3-D Scenes”, SIGGGRAPH 1979, pages 175-181; or Fuchs, Kedem and Naylor, “On Visible Surface Generation by a Priori Tree Structures”, SIGGGRAPH, 1980, pages 124-133) is one alternative data structure which reduces the complexity to an average of O (log N). For example, if a set of 1024 objects are represented using a binary space tree, the searching complexity is reduced to 10 (i.e., log(1024)) to determine which objects are out of range.

Similarly, the well-known “quad tree data structure” (see, for example, A. Klinger, “Patterns and Search Statistics”, Optimizing Methods in Statistics, Academic Press, New York, 1971, pages 303-337; or James D. Foley et al., “Computer Graphics Principles and Practice”, Second Edition, pages 550-555, 1996; or J. Warnock, “A Hidden-Surface Algorithm for Computer Generated Half-Tone Pictures”, Technical Report TR 4-15, NTIS AD-753, 671, Computer Science Department, University of Utah, Salt Lake City, Utah, June 1969) is another known data structure useful for achieving reduced data complexity in rendering graphical representations. For illustrative purposes, FIG. 2 shows one such prior art quad tree data structure 200. Quad tree 200 begins with a bounding rectangle 210, the so-called “root rectangle”, that is defined to contain all the objects under consideration (e.g., in terms of a communications network topology, the objects can be a nodes or links). As additional objects are inserted into quad tree 200, root rectangle 210 will split into four subrectangles (e.g., subrectangles 220-1 through 220-4) of equal dimension. Thus, these four subrectangles become “children” of the root rectangle and as objects continue to be inserted such objects will lie in the area of the subrectangles which in turn will continue to be split in to “fours”, e.g., subrectangles 230-1 through 230-4, as is shown in quad tree 200 In this data structure arrangement, in terms of memory storage, each node is either a pointer to an object (e.g., a communications network node) or a subtree.

In terms of a computer system's memory utilization, this traditional quad tree structure is very efficient for use with main memory and with extremely high performance computer systems (e.g., supercomputers or parallel computing). See, for example, Quentin F. Stout et al., “Adaptive Blocks: A High Performance Data Structure”, SC97 Technical Paper. As will be appreciated, the use of the term “main memory” means the primary memory of a computer system, which typically consists of silicon memory devices. In contrast, a typical computer system's “secondary memory” consists of a magnetic disk hard drive, whereby the secondary memory typically exceeds the amount of primary memory by several orders of magnitude, and the access speed and latency time are significantly different than main memory. Other typical forms of secondary memory include CD-ROM, floppy drives, Zip drives and tape storage.

As highlighted above, the art is replete with known 2D mapping and graphical techniques which work well with main memory and with higher performance computer systems, in rending the display of information regarding a large number of entities (e.g., a large-scale communications network). However, such known techniques present certain challenges when applied to conventional computer systems. In particular, the attribute (of such known techniques) of storing, before displaying a particular rendering, the complete network topology in main memory becomes problematic in terms of conventional computer systems, which are resource limited (e.g., in terms of CPU power and total main memory allocation) as compared to higher performance computer systems. Further, as the network's topology increases in size, it becomes increasingly difficult, if not impossible, for a client user interface program to load the entire large-scale network topology in the main memory of a conventional computer system.

Thus, there exists a need for a graphical display tool which will allow for the display of a very large number of entities (e.g., large-scale network topologies) on a resource limited client program (e.g., a client user interface program executing on a conventional computer system).

### SUMMARY OF THE INVENTION

The present invention provides a method and apparatus for achieving the storing, manipulating and rendering of large-scale 2D displays (e.g., a large-scale communications network topology) using a conventional computer system and its secondary memory. More particularly, the various aspects of the present invention are based on the realization that a modified quad tree data structure in combination with particular indexing and viewing methodologies can achieve the storing, loading, rending, and navigating of, large-scale topologies utilizing the secondary memory of a conventional computer system.

In accordance with an aspect of the invention, a modified quad tree data structure is employed whereby such modified data structure consists of a quad tree modified with a so-called balanced search tree (“B-tree”) such that the modified quad tree structure of the invention divides each of the quad tree's nodes into an array of cells. As such, the modified quad tree structure of the present invention significantly increases the branching factor of the data structure thereby decreasing the number of accesses necessary to secondary memory in rendering a particular display. Therefore, the modified quad tree data structure of the present invention is particularly advantageous for use with the secondary memory of a conventional computer system due to the significant reduction in the total access time and facilitating the access of only those objects that are viewable in the current range. Further, when combined with the further aspects of the invention (as detailed below) directed to indexing and viewing, the present invention provides for the display of a very large number of entities utilizing a conventional computer system and secondary memory.

More particularly, in accordance with a further aspect of the invention, an indexing methodology is applied with the modified quad tree data structure (as detailed above) such that an index table is constructed for use in storing a representation of the desired display information (e.g., a network topology). In particular, in accordance with the preferred embodiment of the invention, objects (e.g., a node or link) are inserted into the cells of the modified quad tree data structure using particular cell identifiers. That is, in accordance with this aspect of the invention, each cell associated with a particular node of the quad tree carries a specific cell identifier such that each cell can hold information about more than one object. Information about each object as detailed above is stored, illustratively, in an object table and such object table is used to load an index table through the insertion and deletion of objects. The populated index table therefore is the finished data structure which defines the respective modified quad tree. Further, in accordance with an aspect of the invention, each quad tree node includes the storage of an object count where such object count equals the number of objects that are defined to be inside or intersecting with the rectangle defined by that particular quad tree node.

In accordance with the preferred embodiment of the invention, the index table contains a complete mapping of the particular topology to be displayed. In accordance with a further aspect of the invention, a viewing of the particular topology is accomplished by applying a so-called “capacity cap” viewing methodology in conjunction with the index table. More particularly, in accordance with this aspect of the invention, a viewer capacity is defined as a function of the total number of objects a viewer can display in a particular screen window and a display capacity density (such display capacity density factor being defined in terms of objects per pixel count). Thus, in accordance with this aspect of the invention, the viewer will render the topology display such that the only objects loaded, and displayed, are objects inside the then current viewing area as defined by the user. Advantageously, the user is able to visualize and navigate through the topology in real-time with the ability to scroll and/or scale a particular display area at any time. Further, in accordance with the preferred embodiment of the invention, main memory stores only that object information necessary to visualize and navigate through that portion of the topology selected by the user (e.g., by scrolling or zooming) in real-time.

Quad trees and balance search trees, as independent data structures, are not new. It has, however, remained for the Applicant herein to recognize that a quad tree data structure can be modified with a balance search tree for the delivery of an improved data structure by which an enhanced graphical display tool can be delivered which allows for the display of a very large number of entities (e.g., large scale network topologies) on a conventional computer system and secondary memory.

### BRIEF DESCRIPTION OF THE DRAWINGS

FIG. 1 shows a prior art display of certain information with respect to an illustrative communications network topology;

FIG. 2 shows a graphical representation of a prior art quad tree data structure;

FIG. 3 shown a graphical representation of the data structure configuration of the present invention;

FIG. 4 shows an illustrative data structure for implementing the data structure configuration of FIG. 3;

FIG. 5 shows a flowchart of illustrative operations for inserting objects in the illustrative data structure of FIG. 4 in accordance with the principles of the invention;

FIG. 6 shows a flowchart of illustrative operations for deleting objects in the illustrative data structure of FIG. 4 in accordance with the principles of the invention;

FIG. 7 shows a flowchart of illustrative operations for viewing objects in the illustrative data structure of FIG. 4 in accordance with the principles of the invention;

FIG. 8 shows an illustrative sequencing of data structure contents in rending an example display in accordance with the principles of the invention;

FIGS. 9A-C show an illustrative sequencing of the actual display of the data structures of FIG. 8; and

FIG. 10 shows an illustrative computer system configuration for implementing the present invention.

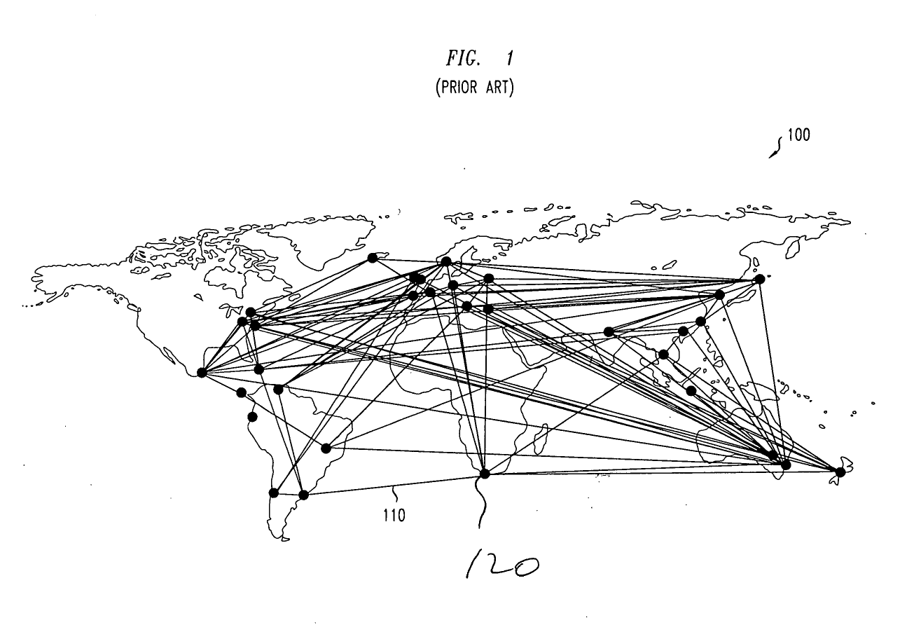

### DETAILED DESCRIPTION

The present invention provides a method and apparatus for achieving the storing, manipulating and rendering of large-scale 2D displays (e.g., a large-scale communications network topology) using a conventional computer system and its secondary memory. More particularly, the various aspects of the present invention are based on the realization that a modified quad tree data structure in combination with particular indexing and viewing methodologies can achieve the storing, loading, rending, and navigating of, large-scale topologies utilizing the secondary memory of a conventional computer system.

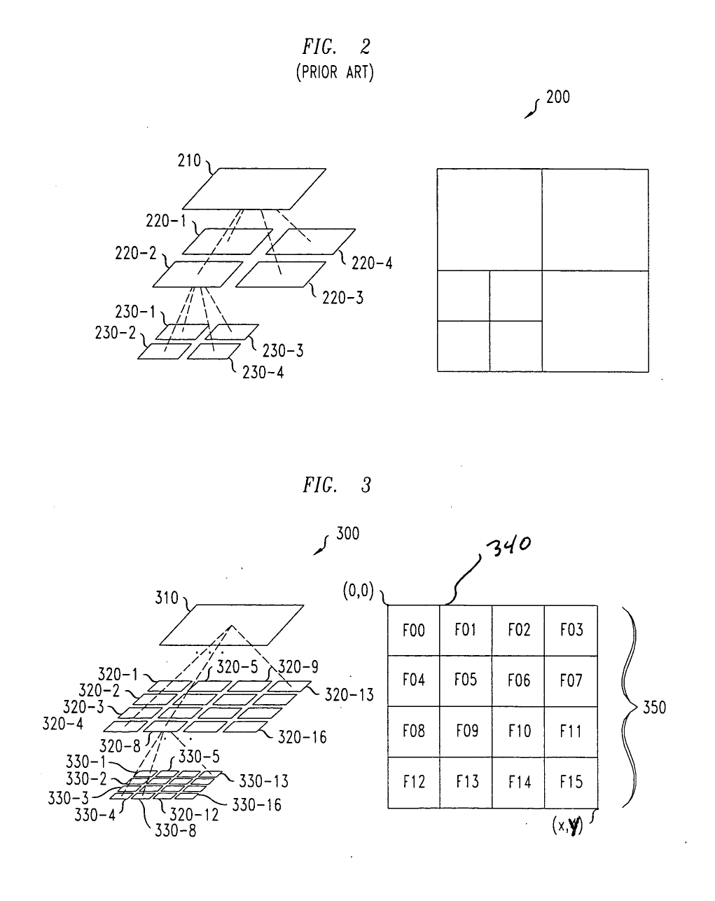

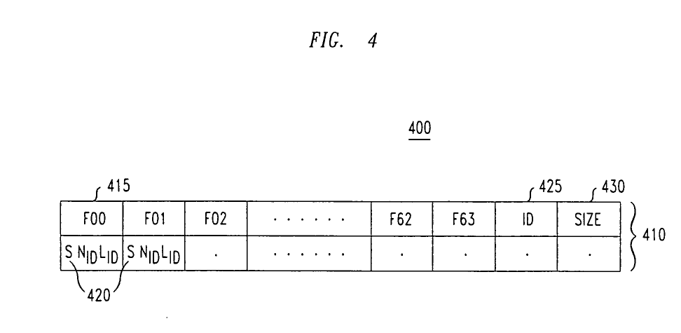

In accordance with an aspect of the invention, a modified quad tree data structure is employed whereby such modified data structure consists of a quad tree modified with a so-called balanced search tree (“B-tree”) such that the modified quad tree structure of the invention divides each of the quad tree's nodes into an array of cells. Referring to FIG. 3, an illustrative data structure 300 is shown which is configured in accordance with this aspect of the invention. As seen in FIG. 3, root rectangle 310, i.e., a quad tree node, is divided into a series of sixteen subrectangles, i.e., subrectangles 320-1 through 320-16, such that each node of data structure 300 is divided into an array of cells. For example, node 320-8 is further subdivided in to sixteen subrectangles 330-1 through 330-16. The capacity of data structure 300 is significantly enhanced over the prior art quad tree 200 (as shown in FIG. 2). For example, if a single cell can hold a pointer to an object, three full layers of data structure 300 with 64 cells can store 262,144 objects (i.e., 64³). In contrast, if quad tree 200 were employed to store the same number of objects it will require nine full layers (i.e., 262144=4⁹). In terms of a display, data structure 300 maps to display 340 in a series 350 of sixteen individual fields, F00 through F15. The insertion of objects in to data structure 300 and the display of objects in fields, e.g., fields F00-F15, is discussed in greater detail hereinbelow.

The modified quad tree structure of the present invention significantly increases the branching factor of the data structure thereby decreasing the number of accesses necessary to secondary storage in rendering a particular display. As such, the modified quad tree data structure of the present invention is particularly advantageous for use with the secondary memory of a conventional computer system due to the significant reduction in the total access time and facilitating the access of only those objects that are viewable in the current viewing range. Further, when combined with the further aspects of the invention (as detailed below) directed to indexing and viewing, the present invention provides for the display of a very large number of entities utilizing a conventional computer system and secondary memory.

FIG. 4 shows an illustrative data structure 400 for implementing the modified quad tree structure of FIG. 3. In particular, data structure 400 includes index table 410 which stores information for each object in fields F00 through F15 (see, FIG. 3). For example, in accordance with the illustrative embodiment of FIG. 4, index table entry 415 is directed to field F00 with the contents of field F00 having the format 420 whereby format 420 (with all other fields having the same format) defines the size of the field (S), the object type as “node” and its identification (N_{ID}), and the object type as link and its identification (L_{ID}). Illustratively, in terms of actual data storage in a secondary memory, S, N_{ID} and L_{ID} are each compressed by radix 36 which allows for satisfactory compression and readability. Index table entry 415 further includes “id” 425 representing an entry for a cell id, and “size” 430 representing the cell size. Each of the other table entries for table 410 are configured in a similar fashion as table entry 415.

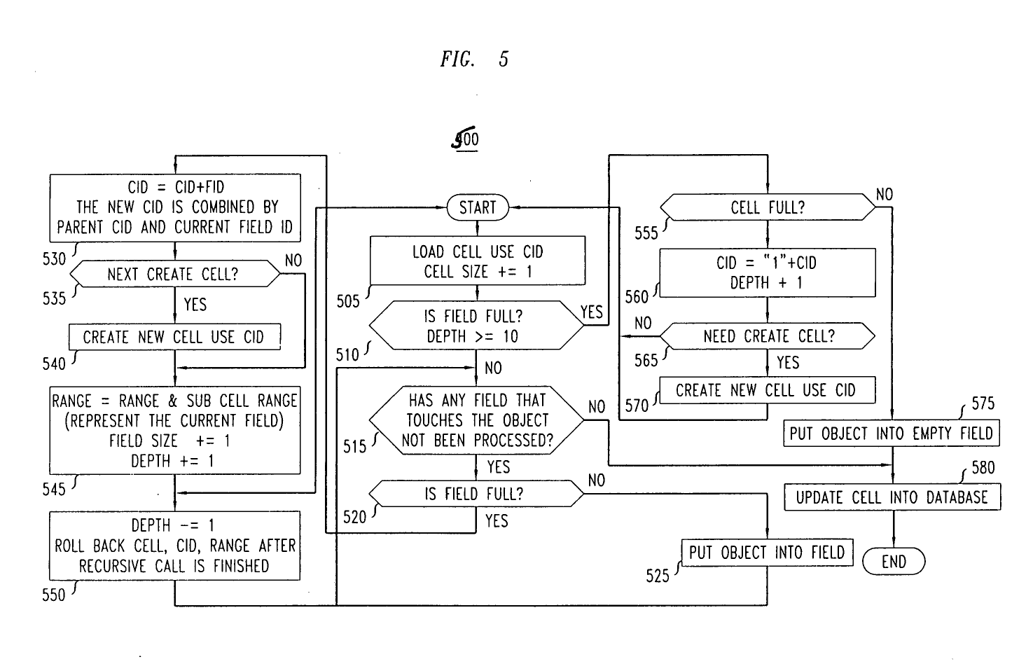

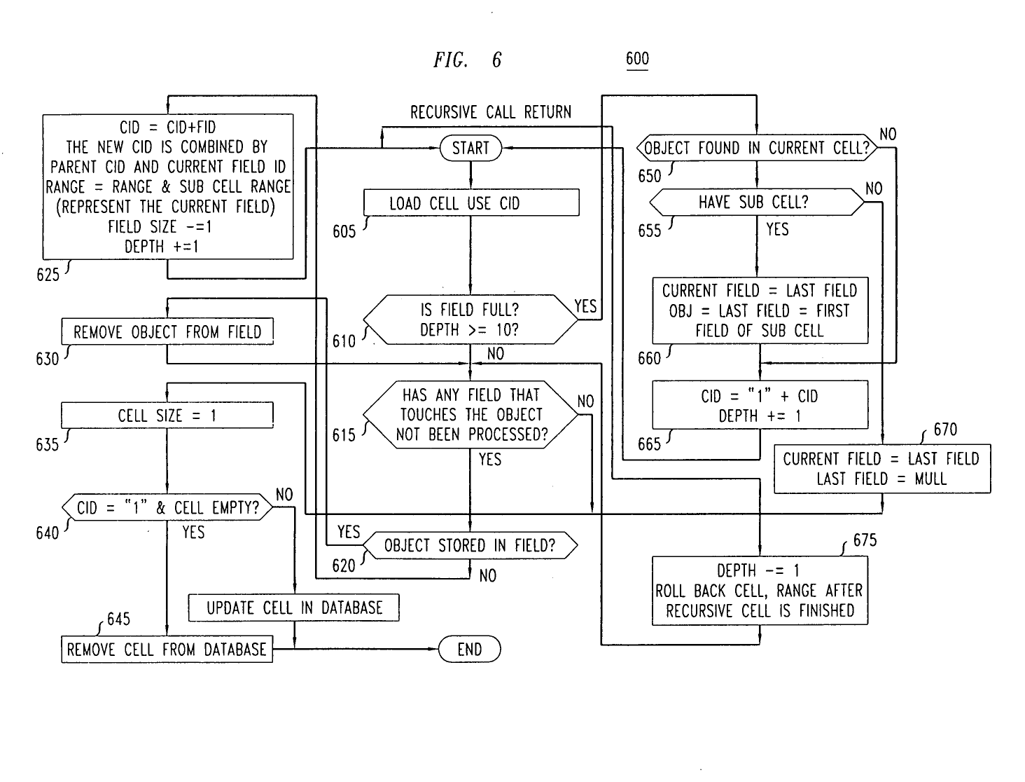

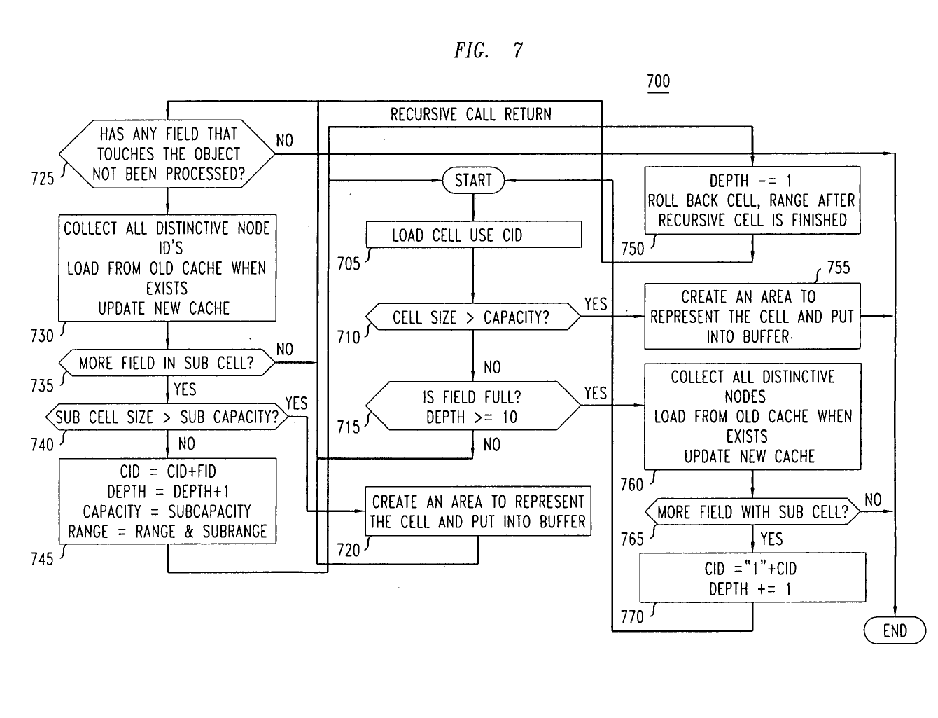

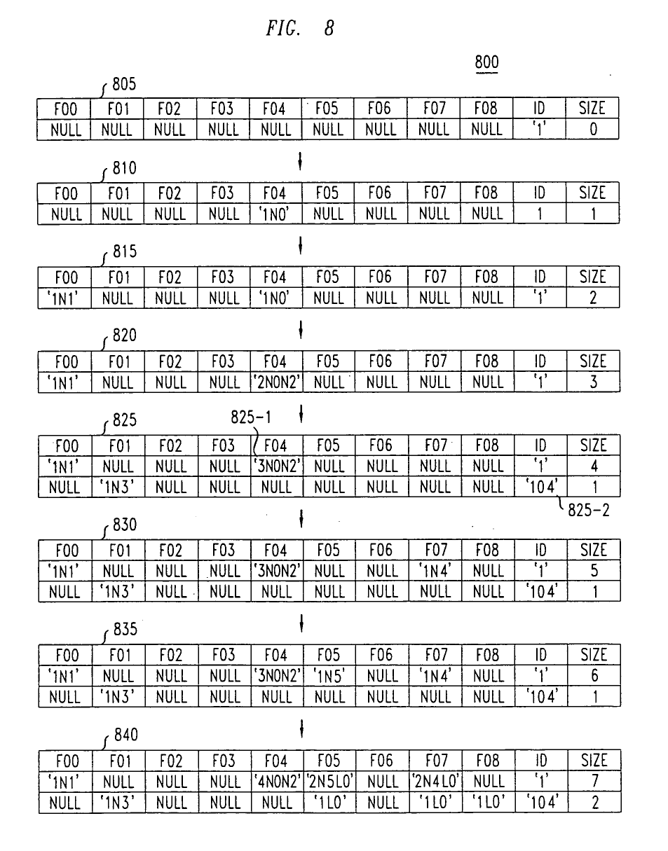

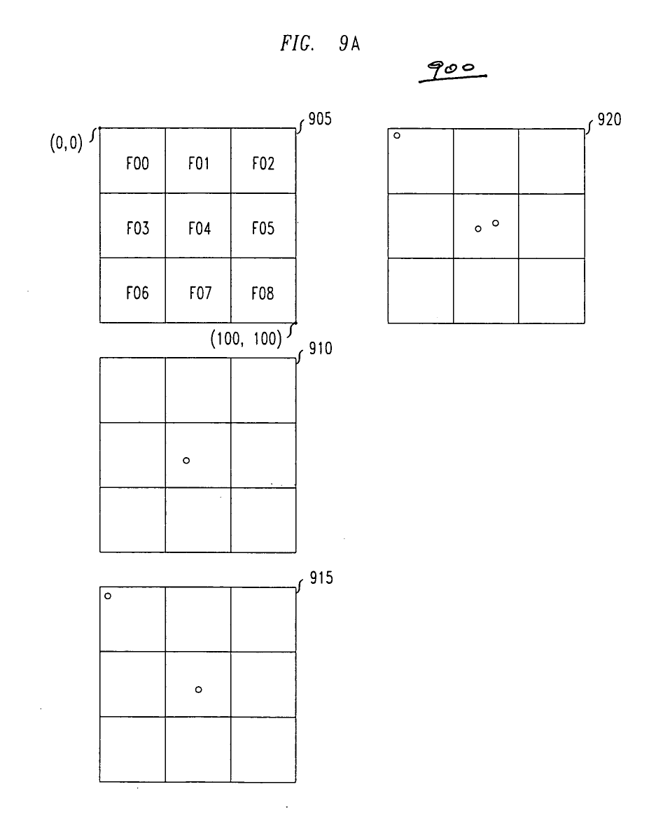

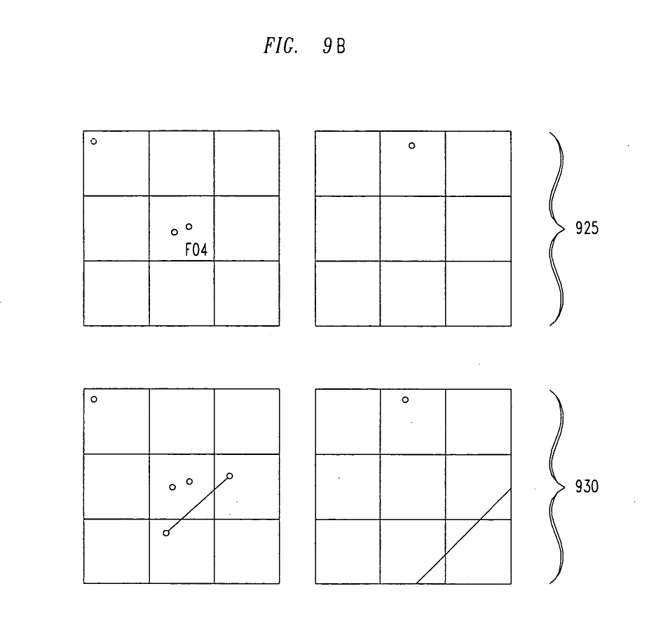

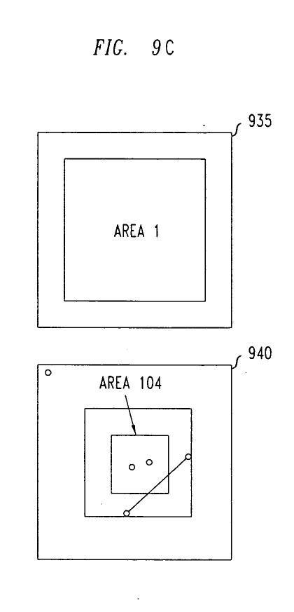

In order to further illustrate the various aspects of the invention and provide a further comprehensive illustration of the present invention, FIG. 5 through FIGS. 9A-C will be discussed together. As will be appreciated, throughout this disclosure, unless otherwise noted, like elements, blocks, components or sections in the Figures are denoted by the same reference designations. Turning our attention to the various Figures, FIG. 5 shows a flowchart of illustrative operations for inserting objects 500 in the illustrative data structure (see, FIG. 4) in accordance with the principles of the invention, FIG. 6 shows a flowchart of illustrative operations for deleting objects 600 in such illustrative data structure, and FIG. 7 shows a flowchart of illustrative operations for viewing objects 700 defined by such illustrative data structure. To further the understanding of the present invention, the above-mentioned operations of inserting, deleting and viewing objects, FIG. 8 and FIGS. 9A-C present an illustrative sequencing of the contents of data structure 800 in rending an example display, and the corresponding illustrative sequencing of the actual display of the data structures 900.

In terms of this illustrative example, the initial state and parameters shall be defined by an original viewing range of (0,0) to (100,100), where each field can store a maximum of 2 object id's, and each cell can divide by 3×3. Thus, the initial index table 805 (see, FIG. 8) shows entries in conformance with this initial state definition (i.e., all fields are the null set, the cell id is “1” as the first cell is yet to be defined and the size of the index table is “0” as it is currently unpopulated) and display sequence 905 (see, FIG. 9) shows an empty view (for illustration purposes with respect to this sequence 905 only, the field numbers (F00-F08) are shown). The first illustrative operation in this example is the insertion of a node in the center area of the display. In particular, the node to be inserted is defined as follows:

NODE 1

| Id | Name | X coordinate | Y coordinate |
|---|---|---|---|
| 0 | node-0 | 45.2 | 50.1 |

Referring to FIG. 5, in accordance with the principles of the invention, the node is inserted into a data structure by loading the cell in terms of the cell id and increasing the cell size (block 505). Next, a determination is made as to whether the particular field is full (block 510). At this point in the illustrative example, the field is not full as each field is capable of storing a maximum of two objects. So, a determination is then made as to whether there is any field that “touches” (i.e., adjacent fields) the particular object in question which has yet to be processed in the data structure (block 515). If all such fields have been processed, the cell is updated (see, block 580). If not, a check is made as to whether the particular field is full (block 520). If the field is not full, the object is inserted into the field (block 525) and the insertion process recursively returns to checking for other unprocessed fields (block 515). If the field is full, the insertion process will create a new cell at the next depth level in the field and insert the particular object in the next cell (blocks 530-550). In accordance with this aspect of the invention, a cell has several fields into which, on a recursive basis, objects may be inserted until such field is full. When a cell's capacity is reached, the cell is divided into further subcells for the continued insertion of objects. In terms of the preferred embodiment of the invention, the depth is an index for a particular cell's layer number. For example, the root cell will have a depth of “0” and the root cell's subcells will have depths 1, 2 and so on. As such, in accordance with a further aspect of the invention, in the event that maximum depth level is reached (e.g., in the current illustrative example, the depth level is 10, see FIG. 5, block 510), the insertion process will increase the depth and create a new cell at such depth (see, FIG. 5, blocks 555 through 575).

In terms of the NODE 1 insertion, the field (i.e., F04 in index table 805) is empty and is populated with the specific information regarding the insertion of NODE 1, as reflected in index table 810. In turn, display sequence 910 (see, FIG. 9A) shows the desired entry of NODE 1 in the updated display area. Continuing with the illustrative example, a second and third node are to be inserted as follows:

NODE 2

| Id | Name | X coordinate | Y coordinate |
|---|---|---|---|
| 1 | node-1 | 3.2 | 4.1 |

NODE 3

| Id | Name | X coordinate | Y coordinate |
|---|---|---|---|
| 2 | node-2 | 52.2 | 48.1 |

NODE 2 and NODE 3 are inserted in a similar fashion as NODE 1. These insertions result in the population of field F00 in index table 815, and field F04 in index table 820 along with the additional respective updates to the various elements of index tables 815 and 820 as shown in FIG. 8. Display sequence 915 and display sequence 920 show the resultant changes in the actual display as a result of the insertion of these two objects.

Significantly, in accordance with this aspect of the invention, the modified quad tree data structure allows for the division of each of the quad tree's nodes into an array of cells, with the division of each cell into fields such that each field is able to store an array of information. As such, the modified quad tree structure of the present invention significantly increases the branching factor of the data structure thereby decreasing the number of accesses necessary to secondary storage in rendering a particular display.

Continuing with the illustrative example, a fourth node is inserted as follows:

NODE 4

| Id | Name | X coordinate | Y coordinate |
|---|---|---|---|
| 3 | node-3 | 54.2 | 34.5 |

Interestingly, the insertion of NODE 4 in the display's center area, in accordance with the invention, will cause field F04 in the data structure (see, index table 820) to become full. That is, in accordance with this illustrative example, an initial operating parameter was that each field can store a maximum of 2 object id's. Of course, as will be appreciated, further embodiments of the invention will contemplate that each field may hold more than 2 object id's but in all cases a field (of any fixed capacity) might become full. As such, the following discussion of the insertion of NODE 4 will apply in all such similar circumstances where a particular field in the data structure becomes full. More particularly, the insertion of NODE 4 begins in the same fashion as NODES 1-3, however, the determination is made that the field is full (see, FIG. 5, block 520). In this case, where field F04 is full a subcell of that field is defined and the object (in this case NODE 4) is inserted in such subcell (see, FIG. 5, blocks 530 through 550). The results of this illustrative insertion are reflected in index table 825. As can be seen from index table 825, field F04 now has a depth of two (see, entry 825-1) with an object id entry (see, entry 825-2) which indicates that the root cell (in this case field F04) also has a subcell. Display sequence 925 (see, FIG. 9B) shows the desired entry of NODE 4 in the display area.

Continuing with the illustrative example, a fifth node, sixth node and link (between nodes 5 and 6) are to be inserted as follows:

NODE 5

| Id | Name | X coordinate | Y coordinate |
|---|---|---|---|
| 4 | node-4 | 44.4 | 56.6 |

NODE 6

| Id | Name | X coordinate | Y coordinate |
|---|---|---|---|
| 5 | node-5 | 73.2 | 44.4 |

LINK 1

| Id | Name | scrId | dltId |
|---|---|---|---|
| 0 | link-0 | 4 | 5 |

The results of these illustrative insertions, in accordance with the present invention, are reflected in index table 830, 835 and 840, respectively. Display sequence 930 (see, FIG. 9B) shows the resultant display of such insertions.

FIG. 6 shows a flowchart of illustrative operations for deleting objects 600 in a data structure. As will be appreciated, deletions will occur, for example, in instances where a user desires to move nodes to a new position which will require an update to the then current index information in the data structure. As can be seen from blocks 605-675, the deletion of objects in accordance with this aspect of the invention occurs with a similar methodology as in the above-detailed insertion operations. That is, the root quad tree node with cells is loaded into main memory and the cells are modified as a function of the object id's. Thus, the deletion operations are essentially the reverse of the insertion operations as detailed above and no further discussion.

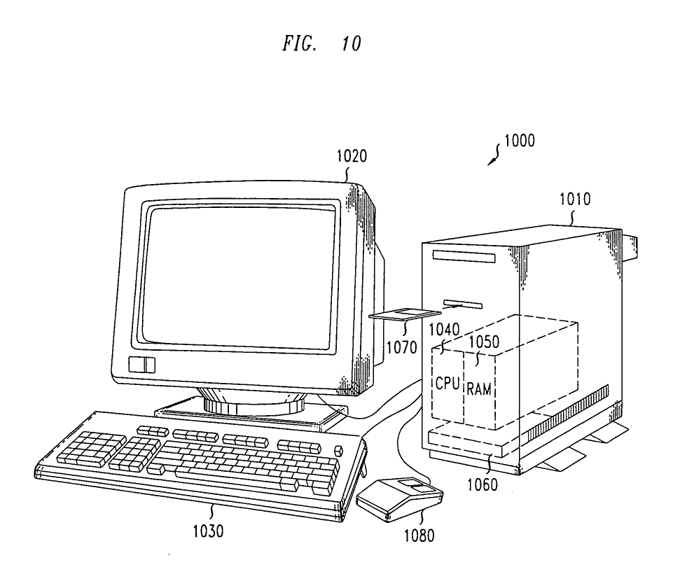

Having illustrated the insertion and deletion of objects in the data structure, in accordance with principles of the invention, the viewing of the contents of the data structure, in accordance with a further aspect of the invention, will now be discussed. More particularly, FIG. 7 shows a flowchart of illustrative operations for viewing objects 700 defined by a data structure (e.g., index table 840 of data structure 800). For purposes of the present illustrative example under discussion, the viewer (e.g., display 1020, see FIG. 10) has a square shape and is initially viewing the entire original viewing range of (0,0) to (100,100). Further, in this example, the viewer is operating on an extremely thin client (e.g., computer system 1000) which can display a maximum of five objects at its current resolution. Importantly, the viewer constructed in accordance with this further aspect of the invention will load only those objects inside the current display area and will automatically limit the number of objects for display at any one time as a function of a display capacity density (i.e., the number of objects per area of display window in square pixels).

For example, if a particular viewer occupies an area of 500×400 square pixels and the viewer has a display capacity density of 0.002, then the total number of objects the viewer can display is 0.0002(500×400)=400 objects. Further, if the user is currently viewing a portion of a particular topology (for example, two percent of the total topology) then the viewer is capable of displaying a topology of 20,000 objects (400/0.02). Thus, the viewer configured in accordance with this aspect of the invention as a function of so-called “capacity cap”. That is, in accordance with this further aspect of the invention, a viewing of the particular topology is accomplished by applying a viewer capacity cap in conjunction with the index table. More particularly, in accordance with this aspect of the invention, a viewer capacity cap is defined as a function of the total number of objects a viewer can display in a particular screen window and a display capacity density (such display capacity density factor being defined in terms of objects per pixel count). Thus, in accordance with this aspect of the invention, the viewer will render the topology display such that the only objects loaded, and displayed, are objects inside the then current viewing area as defined by the user.

Advantageously, the user is able to visualize and navigate through the topology in real-time with the ability to scroll and/or scale particular display area at any time. Further, in accordance with the preferred embodiment of the invention, secondary memory stores only that object information necessary to visualize and navigate through that portion of the topology selected by the user (e.g., by scrolling or zooming) in real-time. Therefore, in accordance with this aspect of the invention, the viewer operations provide for the real-time adaptation to a particular topology with uneven density. That is, if a specific topology has a denser area that other areas, the viewer operates such that the dense area is “marked” and will not be processed until such dense area is within the then current viewer capacity (e.g., via the user “zooming in” on the display).

Turning our attention back to the display of the contents of index table 840, in accordance the present invention, cell “1” is loaded (block 705) into main memory. A determination is then made as to whether the cell size exceeds in the capacity of the viewer (block 710). In terms of the current example, the cell size (i.e., 7) exceeds the capacity of the viewer (i.e., 5). So, an area is created (block 755) to represent cell “1” and its contents are buffered. At this point, as the cell size exceeds the viewer capacity, the user will not see particular objects on the screen but will see the area created to represent the cell (e.g., the rectangle shown in display sequence 935, see FIG. 9C).

Continuing with this illustrative example of viewing the contents of index table 840, suppose the focal point of the display is now set at the center (50,50) of the display, the user zooms at 400%, and the viewer's capacity remains at 5. Thus, the viewing region becomes (25,25) to (75,75), i.e. 25% of the original area, and the viewer can display a total of 20 objects (5×400%) for this region. Now, the cell size (i.e., 7) does not exceed (block 710) the viewer capacity (i.e., 20), so a determination is next made as to whether the field is full, i.e., the depth is over 10 (block 715). If the field is full (i.e., the depth is too deep), a subcell of that field is accessed and the object is processed in accordance with contents of such subcell (see, blocks 760 through 770). The results of this illustrative operation are reflected in index table 825. As can be seen from index table 825, field F04 now has a depth of two (see, entry 825-1). If the field is not full (i.e., the depth is not over 10), a determination is made as to whether all the fields that touch a particular object have been processed (block 725). If not, the operations of blocks 730-750 and block 720 recursively process the fields for viewing and display the respective objects accordingly.

Processing the illustrative contents of index table 840 results in the viewing of the objects and link shown in display sequence 940 (see, FIG. 9C). Importantly, the viewer configured in accordance with this aspect of the invention will only load the current object information that the user has selected for viewing at any particular time. That is, the viewer of the present invention only loads the objects it retrieves in the just previous operation due to that the viewer, in each retrieval, visits the tree along a particular pattern. This is achieved by employing, in accordance with the preferred embodiment of the invention, a level 1 cache in the viewer which holds the objects and tree node in the previous retrieval action. Advantageously, this provides the user with the capability to dynamically operate on large-scale networks in real time on a thin client.

FIG. 10 shows an illustrative computer system configuration for implementing the present invention. In particular, computer system 1000 includes conventional personal computer 1010 which is connected to display 1020 and keyboard 1030. As will be appreciated, information produced by personal computer 1010, e.g., during execution of particular software code, may be displayed on display 1020 for access by a user of computer system 1000. The user, as a result of viewing display 1020, interacts with and controls personal computer 1010, in a conventional manner, using keyboard 1030. Further, mouse 1080, or other well-known pointing devices, may allow the user to provide additional inputs to personal computer 1010. Illustrative computer system 1000 further includes central processing unit (CPU) 1040 which, among other things, may execute a display application software code or GUI to render a large-scale 2D display utilizing internal disk drive memory 1060, i.e., a secondary memory, in accordance with the principles of the present invention as detailed above. Illustratively, such application software code may be loaded into personal computer 1010 via conventional diskette 1070. Further, execution of the code will require access and use of random access memory 1050 (“RAM”) in a conventional manner.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention.

1. A method for rendering a display on a computer system, the display having a plurality of objects, the method comprising the steps of:
loading an index table in a secondary memory of the computer system, the index table containing a plurality of entries directed to particular ones of the objects of the plurality of objects, and the index table being derived from a modified quad tree representation of the display, the modified quad tree consisting of a quad tree and a balanced search tree;
retrieving, from the plurality of entries, information describing the particular ones of the objects; and
rending the display on the computer system as a function of the retrieved information, the display being a two-dimensional representation of the retrieved information.

2. The method of claim 1 wherein the loading of the index table is determined as a function of a viewer capacity cap, the viewer capacity cap being a function of (a) a total number of objects which can be displayed on the computer system and (b) a density factor, the density factor being determined as a function of a number of objects per pixel count.

3. The method of claim 2 wherein the modified quad tree includes a plurality of nodes, each node having a plurality of cells such that each cell may hold information about more than one object of the plurality of objects.

4. The method of claim 3 wherein the modified quad tree is derived as a function of a topology of the display.

5. The method of claim 3 wherein the loaded index table contains entries for only those objects within a viewing area defined by a user of the computer system.

6. The method of claim 3 comprising the further step of:
inserting objects in the index table by modifying the plurality of entries as a function of (i) a cell id associated with a particular cell of the plurality of cells, and (ii) a depth level associated with the plurality of cells.

7. The method of claim 6 wherein the topology is of a communications network.

8. A graphical display system comprising:
a secondary memory;
a processor for executing a user interface application program and for controlling the operation of the graphical display system in accordance with the functions defined by a plurality of program instructions of the user interface application program, the plurality of program instructions defining the steps of:
(i) loading an index table in the secondary memory, the index table containing a plurality of entries directed to particular objects of a plurality of objects of a display, and the index table being derived from a modified quad tree representation of the display, the modified quad tree consisting of a quad tree and a balanced search tree;
(ii) retrieving, from the plurality of entries, information describing the particular objects; and
(iii) rending a two-dimensional representation of the retrieved information;
and;
a monitor for displaying the rendered two-dimensional representation.

9. The graphical display system of claim 8 wherein the loading of the index table is determined as a function of a viewer capacity cap, the viewer capacity cap being a function of (a) a total number of objects which can be displayed on the graphical display system and (b) a density factor, the density factor being determined as a function of a number of objects per pixel count.

10. The graphical display system of claim 8 wherein the modified quad tree includes a plurality of nodes, each node having a plurality of cells such that each cell may store information about more than one object of the plurality of objects.

11. The graphical display system of claim 10 wherein the loaded index table contains entries for only those objects within a viewing area defined by a user of the graphical display system.

12. The graphical display system of claim 10 wherein the plurality of program instructions defining the further step of:
inserting objects in the index table by modifying the plurality of entries as a function of (i) a cell id associated with a particular cell of the plurality of cells, and (ii) a depth level associated with the plurality of cells.

13. A machine-readable medium having stored thereon a plurality of instructions, the plurality of instructions including instructions that, when executed by a machine, cause the machine to perform a method of a rending a two-dimensional display, the two-dimensional display having a plurality of objects, on a computer system by (i) loading an index table in a secondary memory of the computer system, the index table containing a plurality of entries directed to particular ones of the objects of the plurality of objects, and the index table being derived from a modified quad tree representation of the display, the modified quad tree consisting of a quad tree and a balanced search tree; (ii) retrieving, from the plurality of entries, information describing the particular ones of the objects; and (iii) rending the two-dimensional display on the computer system as a function of the retrieved information.

14. The machine-readable medium of claim 13 wherein the loaded index table contains entries for only those objects within a viewing area defined by a user of the computer system.

15. The machine-readable medium of claim 14 wherein the modified quad tree representation of the information is derived as a function of a topology of the two-dimensional display.
